(19) United States
(12) Patent Application Publication
(10) Pub. No.: US 2013/0255790 A1
(43) Pub. Date: Oct. 3, 2013

(54) Emergency Pneumatic Tire Inflator

(71) Applicant: Timothy Alan Cherry, SR., Langley AFB, VA (US)

(72) Inventor: Timothy Alan Cherry, SR., Langley AFB, VA (US)

(21) Appl. No.: 13/790,214

(22) Filed: Mar. 8, 2013

Related U.S. Application Data
(60) Provisional application No. 61/611,221, filed on Mar. 15, 2012.

(51) Int. Cl. F16K 15/20

(52) U.S. Cl. CPC F16K 15/20
USPC 137/12; 137/231

(57) ABSTRACT

This is a pneumatic device used to transfer air from an inflated tire to a deflated tire using a flexible tube and methods of use. The transfer tube is flexible and allows sealed air to transfer through in one direction by using standard screw-on valve connectors on each end and a one-way check valve intersecting the tubing, thus preventing a loss of air from the tire being inflated using no other gauges or mechanical devices.

### BACKGROUND OF THE INVENTION

1. Field of the Invention

The invention relates to inflating a flat tire on a vehicle with air from an inflated tire of the same vehicle in an emergency situation within minutes with very little effort. The device is comprised of materials that can be easily folded and stored inside the vehicle providing years of service.

2. Description of Related Art

There are frequent instances when a tire has become deflated or flattened due to an foreign object or some other type of breech associated with the tire holding air. This may have occurred enroute to or from a destination where the tire had began to gradually lose air to the point of being inoperable. Once this happens, the only safe way to operate the vehicle is to change out the tire with a spare or call an emergency vehicle responder such as a tow company. Both options absorbing an exuberant amount of time in which may not be convenient given the situation. Option one is to change out the flat tire with a spare, given there's one available and second if the spare tire has sufficient air in order to mount onto the vehicle. Even if this first option is available, it will still require a certain amount of physical effort along with being capable of performing this task. The second option obviously requires waiting on a responder which will not only consume time but can also be costly.

An operator of a vehicle having to deal with a flat tire at a moments notice is bothersome to say the least; it can also be dangerous. Being able to quickly and safely inflate a flattened tire to a safe level of operation is a huge advantage for an operator of a vehicle.

Automobile manufacturers have found it necessary to include a spare tire inside of vehicles providing a temporary emergency means of allowing the driver to operate the vehicle. Though thoughtful and useful in some instances, a spare tire has not always provided a sound, safe, solution for all drivers. Some vehicle operators may be limited as far as mechanical skills; some operators may have physical limitations; other drivers may be in locations where it's unsafe to have a vehicle raised and trying to maneuver with other tools and devices. Or, the spare the spare tire is of no use due to being stored and has now loss air.

There is a need for a simple, inexpensive, safe solution, even more so than having a spare tire, to have a simple device that is easy to use, requiring almost no technical skill, that is easily stored inside the vehicle and relies on nothing more than one of the other inflated tires on the vehicle.

The device provides one very important aspect to inflating a tire quickly and without much effort or skill . . . safety. The present invention provides the advantages and benefits outlined herein.

There has been a number of tire inflation devices in which will be described in the related art. However, even as these innovations for inflating tires may satisfy the intended purpose, they are distinctly different from the present invention.

U.S. Pat. No. 6,557,404 (Ziarati) discloses a device for inflating a vehicle tire using an air transfer tube comprising a pressure gauge mounted along a length thereof and which tube is connected at its opposite ends to a pair of air valve chucks each of a size to cooperatively engage and selectively open an air valve of a conventional tire to thereby permit a regulated transfer of air between two or more vehicle tires.

U.S. Pat. No. 7,530,379 (Becker) discloses a device which supplies air to tractor trailer tires using an onboard air supply. This air, supplied to the rotary air chamber system can be adjusted to a desired tire air pressure by the individual driver to suitable levels of load weights, climates, travel speed and terrain. Rotating tires at high speeds build up friction raising tire pressure to dangerous levels. This will be corrected by built in relief valves. To maintain and verify tire pressures each tire is protected by check valves and visible pressure gauges. The rotary air chamber automates, corrects continuously the neglect of proper tire maintenance, adds road safety for users and public alike.

U.S. Pat. No. 7,770,608 (Lighter) discloses a device for delivering nitrogen to multiple tires includes a gas source and supply line connected to a controller. The device also includes a gas delivery line comprising a manifold with a plurality of outlets in fluid communication with each other. A gas delivery line is operably connected to the controller and a plurality of extension lines with engagement chucks are operably connected to the outlets. The controller controls the supply of gas to the gas delivery line and controls a relief valve for venting the gas delivery line. The device also includes a sensor and a processor connected the controller and sensor which accepts user inputs. The controller, manifold and processor are affixed to a stand.

U.S. Pat No. 12,799,992 (Lapera) discloses a device and method for transferring air from a first tire to a second tire which comprises an elongated flexible tube having an air flow passageway therethrough. Two coupling adaptor components are provided, with each attached to a free end of the elongated flexible tube to engage with an air valve of one of the tires. A mechanism in each of the coupling adaptor components is for opening the air valves in one of the tires, to allow air to transfer from the second tire to the first tire that is under inflated, to balance some of the air pressure between the tires.

U.S. Pat. No. 7,963,307 (Rudolf, Winkler, Schwamberger) discloses a device comprising pneumatically controlled wheel valves that are situated in the wheels of a motor vehicle. An electrically actuated pilot valve that is fixed to the vehicle controls the respective wheel valves. To produce a small, low-cost, reliable tire inflation system, a first and a second compressor are provided. The first compressor supplies a first compressed air system with medium-pressure compressed air and the second compressor supplies a second compressed air system with high-pressure compressed air. The wheel valves are situated in the first compressed air system and the pilot valves are situated in the second compressed air system.

### SUMMARY OF THE INVENTION

The present invention provides a fast, safe, means of inflating a deflated tire using a tubed device connected to an inflated tire of the same vehicle.

The present invention requires very minimal physical effort or mechanical ability.

The inflation tube is comprised of a screw on valve stem connector located at each end of the tubing with a one-way check valve intersecting the tubing in which the valve connectors are attached.

The screw on valve stem connectors are threaded on the inside which allows them to be coupled to a tire stem thus opening the valve to began the transfer of pneumatic gases (air).

Furthermore, the one-way check valve system allows air to travel in one direction preventing air loss from the tire being inflated.

The one-way check valve and the screw-on connectors are separate embodiments of the inflator and are only connected to each other through the tubing.

The construction of the present invention allows for long term use and can be easily stored in the vehicle for convenience.

Furthermore, the present invention provides an ease-of-use application for its user.

The following drawings of the present invention will now better describe its preferred embodiments in its practical application. The figures of components are referenced by numerals.

### COMPONENT REFERENCE NUMERALS IN DRAWING

(1a) Screw-On Valve Connector
FIG. 2 Emergency Tire Inflator (present invention)
(2a) One-Way Check Valve
(3a) Flexible Tubing
(3b) Tire Stem
FIG. 4 Operation of Present Invention
(4a) Inflated Tire
(4b) Deflated Tire
(5) Direction of Air Flow

FIG. 1 (1 a), shows an enlarged view of the screw-on valve connector

FIG. 1 (2a), shows an enlarged view of the one-way check valve

FIG. 2 is the enlarged view of the tire inflation device comprising the screw-on valve connectors located at each end of the tubing (1a) and the one-way check valve (2a) attached within the tubing intersecting the connectors (1a).

FIG. 3 shows an enlarged view of a tire stem (3b) attached to an inflated tire (4a) and the part of the tubing (3a) that will attach to the tire stem using the screw-on valve connector (1a).

FIG. 4 illustrates an enlarged view of operation for the present invention. The device is connected to an inflated tire (4a) and a deflated tire (4b) using the valve connectors (1a). FIG. 4 (5) shows the direction of gasses moving through the flexible tubing (3a) and the one-way check valve (2a) controlling the direction of gasses. The one-way check valve (2a) will also prevent air from escaping the tire that was deflated (4b) once the device is disconnected from the inflated tire (4a).

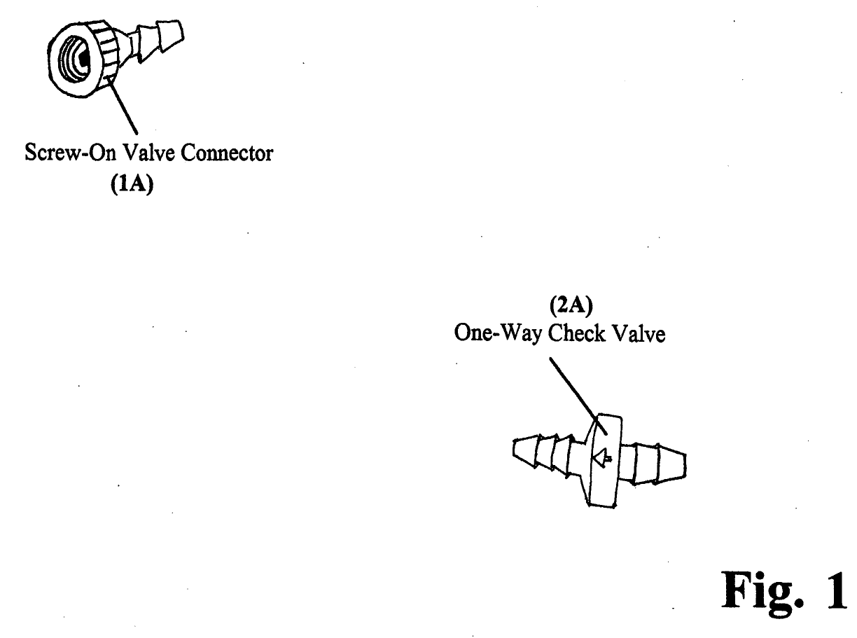

### DETAILED DESCRIPTION OF THE INVENTION

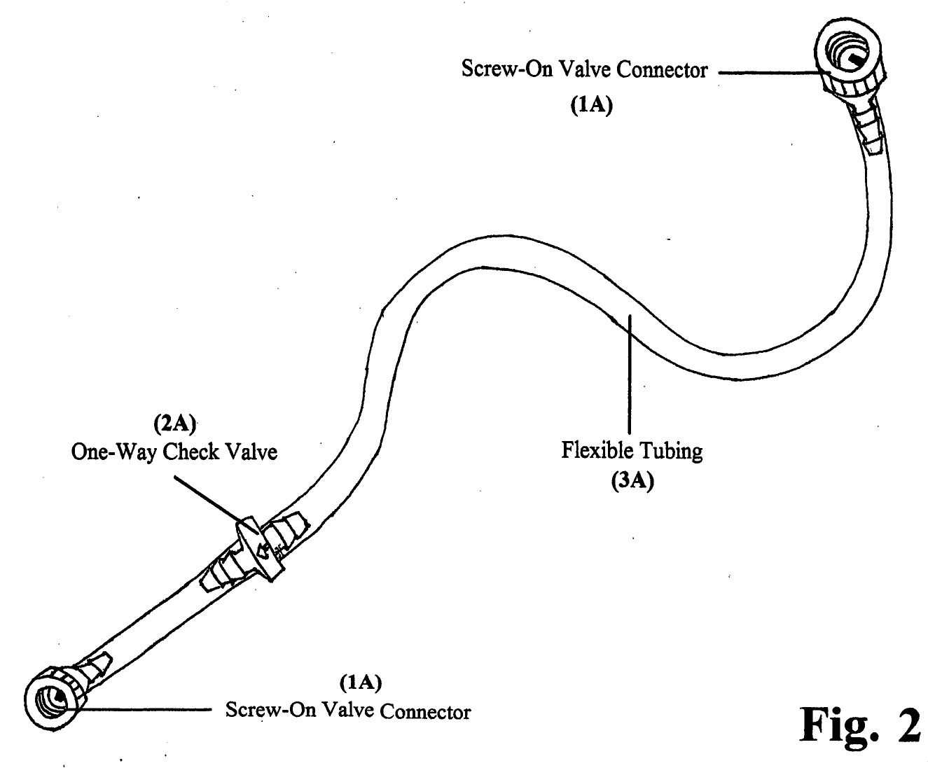

The present invention FIG. 2 is designed to inflate a pneumatic tire on an automobile or any other type of machinery using pneumatic tires.

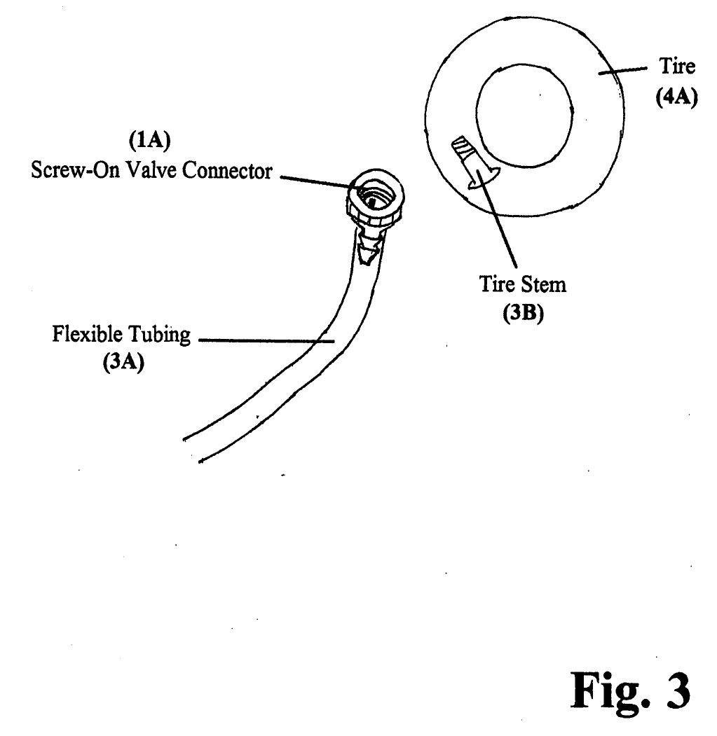

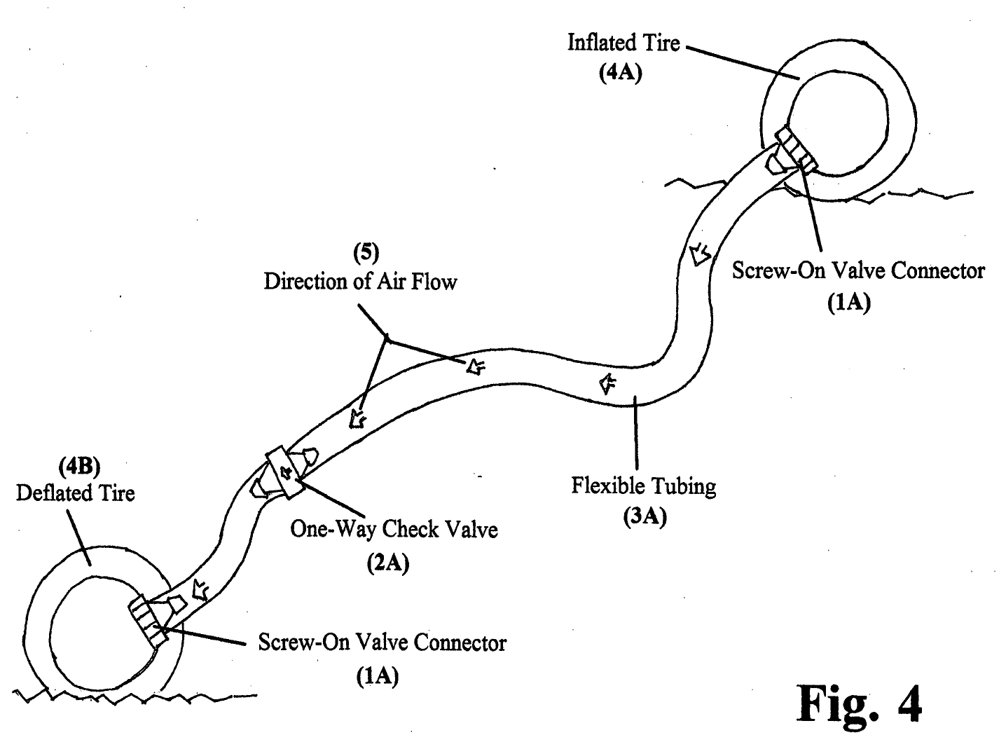

The present invention allows for the transfer of air from an inflated tire FIG. 4 (4a) to a non-inflated tire FIG. 4 (4b) to a safe level of operation without the need of addition devices or equipment. The device is connected using the screw-on valve connectors FIG. 3 (1a) onto the stem of a tire or a rim with a tube FIG. 3 (4a) to initiate the transfer of air through the stem. Once both ends of the device are attached as illustrated in FIG. 4, gasses will now start to transfer form the inflated tire FIG. 4 (1a) to the deflated tire FIG. 4 (4b). The check valve FIG. 4 (2a) only allows the air to travel in one direction FIG. 4 (5) from the inflated tire to the flat tire. This will keep gasses transferred into the flat tire from escaping FIG. 4 (4b). Now both tires have a balanced amount of air that is sufficient for temporary use.

The spare tire of a vehicle is used as an emergency tool in case one of the tires on the vehicle becomes deflated. After a spare tire has been stored over a certain amount of time, it will lose air due to influcuating temperatures and will be of no use thus, leaving the operator immobilized. The present invention deems more necessary than keeping a spare tire in your car. The only other thing needed to make it work is one of the other inflated tires quickly and safely attached to the flat tire FIG. 4.

The emergency tire inflator according to the present invention can be easily folded and stored in the spare tire compartment or an area thereof. Due to the comprised materials, temperature changes will not affect the function of the device. Therefore providing a vehicle operator with a simple, useful, device for inflating a tire quickly and safely in an emergency situation.

While the invention has been illustrated and described as embodiments of a device for transferring air from an inflated tire to a deflated tire, it is understood that any persons skilled in the art could make adjustments to the art described above and the embodiments of the present invention will still be covered.

1. An emergency tire inflation tube which pneumatically transfers sealed air from an inflated tire, on or within a vehicle, to a non inflated tire, on or within the same vehicle within minutes. The transfer tube comprises: a flexible tubing; a standard screw on valve stem connector located at each end of the tubing; a one-way check valve device located within the tubing intersecting between the two screw-on stem connectors.

2. The tire inflator of claim 1, wherein said of flexible tubing comprises plastic, vinyl, rubber, polyethylene, polypropylene, silicone, polyurethane, or pvc.

3. The tire inflator of claim 2, wherein the tubing comprising a rang in length of 9 feet (108 inches) to 14 feet (168 inches).

4. The tire inflator of claim 1, wherein the screw-on valve stem connector comprises metals such as brass, but not limited to.

5. The tire inflator of claim 1, wherein the screw on valve stem connector is internally threaded whereas can be screwed onto a threaded valve stem of a tire.

6. The tire inflator of claim 4, wherein the standard screw-on valve stem connectors located on each end of the tubing allows the valves to open inside the stem of the tire allowing air move through in either direction.

7. The tire inflator of claim 1, wherein the one-way check valve is located within the tubing intersecting the flow of air between the screw-on valves located on each end of the tubing.

8. The tire inflator of claim 6, wherein the one-way check valve device located within the tubing allows air to only move in one direction preventing loss of air from the tire being inflated once the stem connector from the source tire is disconnected.

9. The method of inflating a flat tire with air from tires of the same vehicle within minutes using flexible tubing comprising; flexible tubing with a screw-on valve stem connector on each end allowing the tubing to couple with the tire valve. Once connected, the air will transfer into the flat tire from the source tire and will balance out the pressure within minutes. The check valve within the tubing intersecting the connectors only allows air to travel into the flat tire preventing loss of air when the valve is disconnected from the tire providing the air.

10. The method of claim as recited in claim 8, wherein the tire inflator comprises a one-way check valve within the tubing, intersecting the flow of air between the screw on valve connectors.
